(19) United States
(12) Patent Application Publication
(10) Pub. No.: US 2012/0002723 A1
(43) Pub. Date: Jan. 5, 2012

(54) STEREO VIDEO CODING APPARATUS AND STEREO VIDEO CODING METHOD

(76) Inventors: Hiroshi ARAKAWA, Nara (JP); Hideyuki OHGOSE, Osaka (JP); Yuki KOBAYASHI, Osaka (JP); Kiyofumi ABE, Osaka (JP); Katsuki URANO, Nara (JP); Yuki MARUYAMA, Osaka (JP)

(21) Appl. No.: 13/171,736

(22) Filed: Jun. 29, 2011

(30) Foreign Application Priority Data
Jun. 30, 2010 (JP) 2010-150469
Jun. 27, 2011 (JP) 2011-142188

(51) Int. Cl. H04N 7/28

(52) U.S. Cl. 375/240.03; 375/E07.14

(57) ABSTRACT

A stereo video coding apparatus which codes, out of a first viewpoint video and second viewpoint video, at least a second image included in the second viewpoint video, and includes: a judgment unit and a selection unit which output one of a prediction image generated by applying motion compensation to the second viewpoint video and a prediction image generated by applying disparity compensation to the first viewpoint video, by selectively switching between the prediction images; a subtractor; an orthogonal transform unit; a quantization unit; and a control unit which determines a quantization step size to be used by the quantization unit. The control unit determines a quantization step size to be applied to the second image to be a value smaller than a quantization step size to be applied to a first image that is paired with the second image, when the judgment unit selects the prediction image generated by applying disparity compensation.

### BACKGROUND OF THE INVENTION

(1) Field of the Invention

The present invention relates to stereo video coding apparatuses and stereo video coding methods, and particularly relates to an apparatus and method which compression-code a stereo video, using disparity compensation.

(2) Description of the Related Art

In recent years, digitalization of AV information is advancing, and devices that can handle video signals by digitalization are becoming widely popular. Since the amount of information included in a video signal is large, it is a common practice to perform coding while reducing the amount of information, in consideration of recording capacity and transmission efficiency. An international standard developed by a working group called the Moving Picture Experts Group (MPEG) is widely used as a technique for coding video signals.

Patent Reference 1 (Japanese Patent Number 3646849) discloses a stereo video coding apparatus which codes a stereo video signal using such a video compression-coding technique. The conventional stereo video coding apparatus described in Patent Reference 1 codes a stereo video signal which includes a left-eye video and a right-eye video used in stereoscopic viewing. Hereinafter, a case where the left-eye video (left channel video) is a base channel and the right-eye video (right channel video) is an extended channel shall be described. Specifically, the conventional stereo video coding apparatus refers to the left-eye video which is the base channel, when coding the right-eye video which is the extended channel.

The conventional stereo video coding apparatus described in Patent Reference 1 performs rate control. Rate control is a process of controlling the bit rate of a bitstream by determining the quantization step size in quantization, based on the amount of code generated by coding of a stereo video signal. For example, rate control is executed according to (Equation 1) to (Equation 7) below.

d=d0+s−j×(T1/Nmb) (Equation 1)

Here, d is the virtual buffer occupancy. Nmb is the number of macroblocks in a picture. j (=0, 1, Nmb−1) is a value indicating the position of a current macroblock. T1 is a target bit rate for both a first picture for the left eye and a second picture for the right eye which are 1 pair of current pictures. Furthermore, d0 is the value of d after the coding of the preceding picture.

Next, dL to be used in the quantization of a left-eye image which is the base channel is calculated according to (Equation 2), using the value calculated according to (Equation 1).

dL=(½)×d (Equation 2)

In addition, a quantization parameter mquant is calculated by performing the following computations according to (Equation 3) to (Equation 6).

mquant=Qj×Nactj (Equation 3)

Qj=32×dL/r (Equation 4)

r=2×(bit rate)×(picture rate) (Equation 5)

Nactij=(2×actj+avg_act)/(actj+2×avg_act) (Equation 6)

Here, actj is the activity of the current macroblock, and avg_act is the average value of the actj of the immediately preceding picture. As described above, the quantization parameter mquant calculated according to (Equation 2) to (Equation 6) is used in the quantization of the left-eye image.

In addition, dR to be used in the quantization of a right-eye image which is the extended channel is calculated according to (Equation 7), using the value calculated according to (Equation 1).

dR=(WR′)×d (Equation 7)

Here, WR′≧(½). In addition, the quantization parameter mquant is calculated according to (Equation 8) below, and aforementioned (Equation 3), (Equation 5), and (Equation 6).

Qj=32×dR/r (Equation 8)

As described above, the quantization parameter mquant calculated according to (Equation 8), (Equation 3), (Equation 5), and (Equation 6) is used in the quantization of the right-eye image.

In the conventional stereo video coding apparatus, the quantization parameter applied to the right channel (extended channel) becomes larger than the parameter applied to the left channel (base channel). As a result, the amount of generated code for the right channel decreases, and high coding efficiency is realized. Furthermore, the picture quality of the base channel is controlled so as to be kept higher than the picture quality of the extended channel at all times.

Furthermore, Patent Reference 2 (Japanese Patent No. 3122191) discloses a method in which the compression rates for the left channel and the right channel are switched alternately in order to improve coding efficiency.

### SUMMARY OF THE INVENTION

However, in the above-described techniques, there is the problem that, in the coding of stereo video, coding distortion occurs in the extended channel and thus picture quality deteriorates. Specifically, the problem is as follows.

When the control for making the quantization parameter of the extended channel larger than the quantization parameter of the base channel, such as that performed in the above-described conventional technique, is performed, deterioration (ringing, and so on) of the extended channel occurs and what is called mosquito noise appears in the vicinity of the edges.

FIG. 10 is a diagram showing a schematic view of (a) a left-eye image and (b) a right-eye image when an image of a rectangular prism is captured, and the horizontal distribution of pixel values at the pixel lines represented by the broken lines. In the example shown in FIG. 10, pixel values are large at the front face of the rectangular prism, and pixel values at the side faces (left-side face and right-side face) of the rectangular prism are approximately half of the pixel values of the front face.

Furthermore, FIG. 11 is a diagram showing the distribution of residual pixels when a right-eye image is coded by performing disparity compensation with a left-eye image as a reference image. It should be noted that, in FIG. 11, the square region shown with bold lines in the right-eye image is the current macroblock to be coded. Furthermore, in FIG. 11, the square region shown with bold lines in the left-eye image is the reference image.

The current macroblock includes the right-side face of the rectangular prism but pixels corresponding to the region of the right-side face of the rectangular prism are not present in the left-eye image which is the reference image. As such, the residual pixel value for a section in which there is no corresponding pixel becomes non-zero.

Then, when the orthogonal transform result for such a residual pixel is quantized using an insufficient quantization parameter (that is, a large quantization parameter), a quantization error occurs in the orthogonal transform coefficient. As a result, when quantized orthogonal transform coefficients are restored to a spatial domain by performing inverse-quantization and inverse-orthogonal transform, the orthogonal transform coefficients do not return to the original clean rectangular waves and instead become rectangular waves including ringing.

Therefore, adding rectangular waves that include ringing and reference pixels results in the distribution of coded pixels with ringing as shown in (b) in FIG. 12. As shown in FIG. 12, ringing appears, not only in an edge portion, but also in nearby sections (A) and (B) in which pixel values are normally fixed.

Furthermore, in a location in which pixels in the reference image are discontinuous as in a pixel position (C), there are cases where greater ringing appears. This is the noise which appears in a location in which the pixel value is fixed in the current image to be coded, and is the noise which appears only in one of the stereo images when corresponding positions are compared in the case of stereoscopic viewing. As such, it is a noise that is unpleasant to a viewer and thus subjectively undesirable. Such a noise causes picture quality deterioration to an unacceptable degree particularly in the coding of high-bit rate, high-quality stereo images.

In view of this, present invention has as an object to provide a stereo video coding apparatus and a stereo video coding method which are capable of reducing deterioration of picture quality, by suppressing coding distortion occurring in an extended channel during coding of a stereo video.

In order to solve the aforementioned problems, the stereo video coding apparatus according to an aspect of the present invention is a stereo video coding apparatus which codes at least a second image included in a second viewpoint video out of a first viewpoint video of a first viewpoint and the second viewpoint video of a second viewpoint, the first viewpoint video and the second viewpoint video making up a video for stereoscopic viewing, the stereo video coding apparatus including: a judgment unit configured to output one of a prediction image generated by applying motion compensation to a picture included in the second viewpoint video and a prediction image generated by applying disparity compensation to a picture included in the second viewpoint video, by selectively switching between the prediction images; a subtractor which calculates a difference between the prediction image output by the judgment unit and the second image, to generate a residual component; an orthogonal transform unit configured to perform orthogonal transform on the residual component generated by the subtractor, to generate an orthogonal transform coefficient; a quantization unit configured to perform quantization on the orthogonal transform coefficient generated by the orthogonal transform unit, to generate a quantization coefficient; and a control unit configured to determine a quantization step size to be used by the quantization unit, wherein the control unit is configured to determine a quantization step size to be applied to the second image to be a value smaller than a quantization step size to be applied to a first image included in the first viewpoint video, when the judgment unit selects the prediction image generated by applying disparity compensation, the first image being paired with the second image.

Accordingly, when disparity compensation is to be used in the coding of the second image (extended channel), the quantization step size to be used in the quantization of the second image can be made smaller than the quantization step size to be used in the quantization of the first image (base channel) which is paired with such second image. As a result, occurrence of coding distortion is suppressed and deterioration of picture quality is reduced. In particular, since it is possible to suppress the occurrence of ringing which appears in only one of the images of stereoscopic images when disparity compensation is performed, deterioration of picture quality can be further suppressed.

Furthermore, in the stereo video coding apparatus according to an aspect of the present invention, the judgment unit may be configured to judge, on a picture basis, which one of the prediction image generated by applying motion compensation and the prediction image generated by applying disparity compensation to select, and the control unit may include a rate control unit configured to determine the quantization step size to be applied to the second image to be a value smaller than the quantization step size to be applied to the first image, when the judgment unit selects the prediction image generated by applying disparity compensation.

Accordingly, by adjusting the quantization step size on a picture basis, it is possible to suppress the coding distortion occurring in the picture of the extended channel, and suppress the deterioration of picture quality. It should be noted that when disparity compensation is to be performed, the difference (prediction error) for most regions in a picture is 0 or a negligibly-small value. As such, the increase in the amount of code due to the use of a small quantization step size is extremely small. Therefore, according to the stereo video coding apparatus in the present aspect, picture quality can be improved for a small increase in the amount of code.

Furthermore, in the stereo video coding apparatus according to an aspect of the present invention, the first image may be an image that is part of a first picture included in the first viewpoint video, the second image may be an image that is part of a second picture included in the second viewpoint video, the judgment unit may be configured to judge which one of the prediction image generated by applying motion compensation and the prediction image generated by applying disparity compensation to select in the coding of the second picture, and the control unit may be configured to determine the quantization step size to be applied to the second image to be a value smaller than the quantization step size to be applied to the first image, when the judgment unit selects the prediction image generated by applying disparity compensation.

Accordingly, since the occurrence of ringing can be suppressed even when a block to be motion compensated and a block to be disparity compensated are present together in a picture, deterioration of picture quality can be suppressed. Furthermore, since the regions on which a small quantization step size is used are reduced compared to when a small quantization step size is used on the entirety of the picture, coding efficiency can be increased.

Furthermore, the stereo video coding apparatus according to an aspect of the present invention may further include a scalar amount calculation unit configured to, when the judgment unit selects the prediction image generated by applying disparity compensation, calculate a scalar amount indicating features of a difference image which is a difference between the selected prediction image and the second image, wherein the control unit may be further configured to determine the quantization step size to be applied to the second image, based on the scalar amount, when the judgment unit selects the prediction image generated by applying disparity compensation.

With this, the value of the quantization step size can be changed according to the scalar amount indicating the feature amount of the difference image. As a result, the subjective picture quality can be improved.

Furthermore, in the stereo video coding apparatus according to an aspect of the present invention, the scalar amount may be a sum of absolute differences of the difference image, and the judgment unit may be configured to determine the quantization step size to be applied to the second image to be a smaller value when the scalar amount is larger.

Generally, when the scalar amount is large, the amount of code generated in the coding of the residual image is large, and the ringing noise, and so on, is more noticeable. However, according to the stereo video coding apparatus in the present aspect, a quantization step size having a small value is used when the scalar amount is large, and thus the occurrence of ringing can be suppressed. Specifically, when ringing is noticeable, a smaller quantization step size can be used, thereby allowing the subjective picture quality to be improved.

Furthermore, in the stereo video coding apparatus according to an aspect of the present invention, the quantization step size may be a value determined according to at least one of a quantization matrix and a quantization parameter, and the control unit may be configured to determine at least one of coefficient values of a quantization matrix to be used in quantization of the second image to be a value smaller than a coefficient value of a quantization matrix to be used in quantization of the first image, when the judgment unit selects the prediction image generated by applying disparity compensation.

Accordingly, since the values of a quantization matrix can be set for each position of a frequency conversion coefficient, precise quantization can be performed and thus deterioration of picture quality can be suppressed.

Furthermore, in the stereo video coding apparatus according to an aspect of the present invention, the quantization step size may be a value determined according to at least one of a quantization matrix and a quantization parameter, and the control unit may be configured to determine a quantization parameter to be used in quantization of the second image to be a value smaller than a quantization parameter to be used in quantization of the first image, when the judgment unit selects the prediction image generated by applying disparity compensation.

Accordingly, since the quantization parameter can be adjusted, for example, on a macroblock basis, the quantization parameter can be changed according to the current macroblock to be coded, and thus deterioration of picture quality can be suppressed.

It should be noted that the present invention can be implemented, not only as a stereo video coding apparatus, but also as a method having, as steps, the processing units included in such stereo video coding apparatus. Furthermore, the present invention can also be implemented as a program which causes a computer to execute such steps. In addition, the present invention may also be implemented as a recoding medium such as a computer-readable Compact Disk-Read Only Memory (CD-ROM) on which such program is recorded, and as information, data, or a signal representing such program. In addition, such program, information, data and signal may be distributed via a communication network such as the Internet.

Furthermore, a part or all of the constituent elements included in the respective stereo video coding apparatuses described above may be structured as a single system LSI (Large Scale Integration). The system LSI is a super multi-functional LSI manufactured by integrating a plurality of structural units onto a single chip. Specifically, it is a computer system configured by including a microprocessor, a ROM, a Random Access Memory (RAM), and the like.

According to the present invention, deterioration of picture quality can be reduced by suppressing the coding distortion occurring in the extended channel in the coding of the stereo video.

### FURTHER INFORMATION ABOUT TECHNICAL BACKGROUND TO THIS APPLICATION

The disclosure of Japanese Patent Applications No. 2010-150469 filed on Jun. 30, 2010, and 2011-142188 filed on Jun. 27, 2011 including specification, drawings and claims are incorporated herein by reference in their entirety.

### BRIEF DESCRIPTION OF THE DRAWINGS

These and other objects, advantages and features of the invention will become apparent from the following description thereof taken in conjunction with the accompanying drawings that illustrate a specific embodiment of the invention. In the Drawings:

FIG. 1 is a block diagram showing an example of a configuration of a stereo video coding apparatus according to Embodiment 1;

FIG. 2 is a block diagram showing an example of details a coding processing unit and a control unit of the stereo video coding apparatus according to Embodiment 1;

FIG. 3A is a flowchart showing an example of basic operations of the stereo video coding apparatus according to Embodiment 1;

FIG. 3B is a flowchart showing an example of operations of the stereo video coding apparatus according to Embodiment 1;

FIG. 4 is a block diagram showing an example of a configuration of a stereo video coding apparatus according to Embodiment 2;

FIG. 5 is a flowchart showing an example of operations of the stereo video coding apparatus according to Embodiment 2;

FIG. 6 is a block diagram showing an example of a configuration of a stereo video coding apparatus according to Embodiment 3;

FIG. 7 is a graph showing an example of the relationship between a scalar amount and WR according to Embodiment 3.

FIG. 8 is a flowchart showing an example of operations of the stereo video coding apparatus according to Embodiment 3;

FIG. 9 is a block diagram showing an example of a configuration of a stereo video coding apparatus according to a modification of Embodiment 1;

FIG. 10 is a diagram for describing the operation of a conventional stereo video coding apparatus, and shows an example of a left-eye image and a right-eye image, and the distribution of pixel values thereof;

FIG. 11 is a diagram for describing the operation of a conventional stereo video coding apparatus, and shows an example of a left-eye image and a right-eye image, and the distribution of residual pixels when disparity compensation is performed; and

FIG. 12 is a diagram showing ringing appearing in a coded image due to quantization error in a residual pixel in the case where disparity compensation is performed by a conventional stereo video coding apparatus.

### DESCRIPTION OF THE PREFERRED EMBODIMENT(S)

Hereinafter, the embodiments of the stereo video coding apparatus and stereo video coding method according to the present invention shall be described with reference to the Drawings.

### First Embodiment

The stereo video coding apparatus according to Embodiment 1 of the present invention is a stereo video coding apparatus which codes at least a second image included in a second viewpoint video out of a first viewpoint video of a first viewpoint (video of a base channel) and the second viewpoint video of a second viewpoint (video of an extended channel), which make up a video for stereoscopic viewing. The stereo video coding apparatus according to Embodiment 1 of the present invention includes: a judgment unit which outputs one of a prediction image generated by applying motion compensation to a picture included in the second viewpoint video and a prediction image generated by applying disparity compensation to a picture included in the second viewpoint video, by selectively switching between the prediction images; a subtractor which calculates a difference between the prediction image output by the judgment unit and the second image, to generate a residual component; an orthogonal transform unit which performs orthogonal transform on the residual component generated by the subtractor, to generate an orthogonal transform coefficient; a quantization unit which performs quantization on the orthogonal transform coefficient generated by the orthogonal transform unit, to generate a quantization coefficient; and a control unit which determines a quantization step size to be used by the quantization unit. The control unit determines a quantization step size to be applied to the second image to be a value smaller than a quantization step size to be applied to a first image included in the first viewpoint video and paired with the second image, when the judgment unit selects the prediction image generated by applying disparity compensation.

In essence, a feature of the stereo video coding apparatus according to Embodiment 1 is making the quantization step size to be applied to the extended channel smaller than the quantization step size to be applied to the base channel, when disparity compensation is to be performed in the coding of the extended channel. Specifically, the stereo video coding apparatus according to Embodiment 1 judges, on a picture basis, whether to perform disparity compensation or motion compensation.

It should be noted that, in Embodiment 1, the first image is an image making up a first picture included in the first viewpoint video, and the second image is an image making up a second picture included in the second viewpoint video.

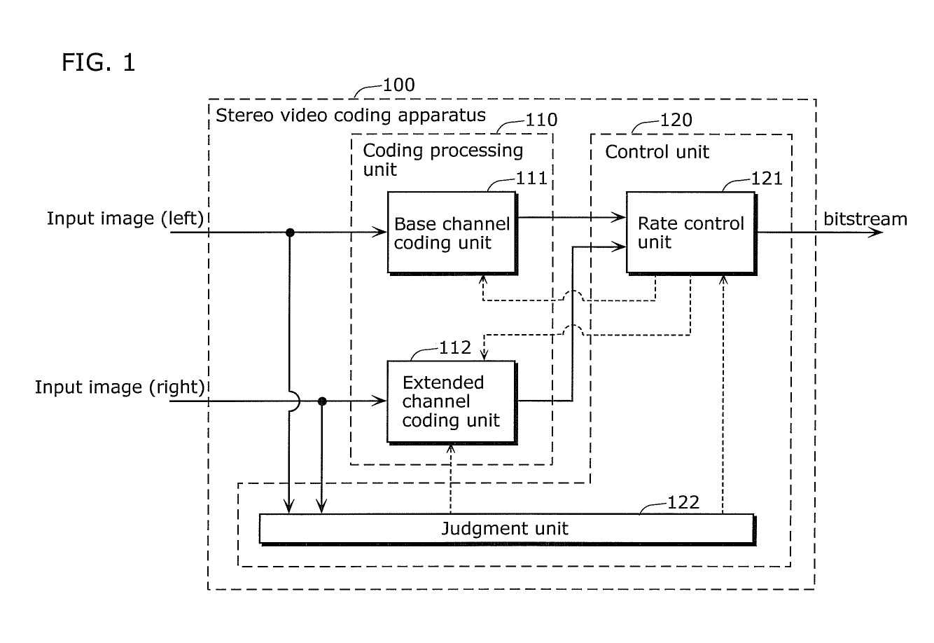

FIG. 1 is a block diagram showing an example of a configuration of a stereo video coding apparatus 100 according to Embodiment 1.

FIG. 1 is a block diagram showing an example of a configuration of a stereo video coding apparatus 100 according to Embodiment 1. More specifically, the stereo video coding apparatus 100 codes at least the second image included in the second viewpoint video out of the first view point video of a first view point and the second viewpoint video of a second viewpoint which make up a video for stereoscopic viewing.

For example, the first viewpoint video is a video for the left eye, and includes a first picture for the left eye. The second viewpoint video is a video for the right eye, and includes a second picture for the right eye. It should be noted that, in Embodiment 1, the first viewpoint video is a base channel video, and the second viewpoint video is an extended channel video.

A base channel video is coded by performing intra prediction and/or motion compensation. Furthermore, an extended channel video is coded by performing intra prediction, motion compensation, and/or disparity compensation. When disparity compensation is performed, an image included in the base channel video is used as a reference image.

The stereo video coding apparatus 100 according to Embodiment 1 judges, on a picture basis, whether or not to perform disparity compensation in the coding of the extended channel video. As shown in FIG. 1, the stereo video coding apparatus 100 includes a coding processing unit 110 and a control unit 120.

The coding processing unit 110 codes the first viewpoint video and the second viewpoint video by performing intra prediction, motion compensation or disparity compensation, and quantization. As shown in FIG. 1, the coding processing unit 110 includes a base channel coding unit 111, and an extended channel coding unit 112.

The base channel coding unit 111 codes the base channel video, that is, the first viewpoint video. The base channel coding unit 111 obtains an input image (first picture) for the left eye included in the first viewpoint video, and codes the first picture by performing intra prediction or motion compensation, and quantization.

The extended channel coding unit 112 codes the extended channel video, that is, the second viewpoint video. The extended channel coding unit 112 obtains an input image (second picture) for the right eye included in the second viewpoint video, and codes the second picture by performing intra prediction, motion compensation or disparity compensation, and quantization.

The control unit 120 determines the quantization step size to be used in the quantization by the coding processing unit 110. Specifically, when the coding processing unit 110 performs disparity compensation in coding the second image included in the second viewpoint video, the control unit 120 determines the quantization step size to be applied to the second image to be a smaller value than the quantization step size to be applied to the first image which is included in the first viewpoint video and is a pair with the second image.

Furthermore, when the coding processing unit 110 will not perform disparity compensation in coding the second image, the control unit 120 can determine each of the quantization step size to be applied to the first image and the quantization step size to be applied to the second image independently of each other.

Here, “the first image that is a pair with the second image” means a case where the first image satisfies at least the condition (i) described below.

(i) When the second image is one of a left image and a right image that are for stereoscopic viewing using left/right disparity, the first image is the other of the images which corresponds to the second image.

Stated differently, when the first image and the second image are displayed successively or simultaneously to form a stereoscopic image in the sight of a viewer, the first image is the image that is paired with the second picture.

It should be noted that, in this case, the first picture has a high correlation with the second image. As such, generally, the first image is often used as a reference image for disparity compensation in the coding of the second picture.

For example, the first image is an image captured at the same image-capturing time as the second image. Specifically, the first image is an image of a first picture for the left eye, and the second image is an image of a second picture for the right eye that is captured at the same time as the first picture. The viewer can stereoscopically view an image formed by the first picture and the second picture, by viewing the first picture with the left eye and viewing the second picture with the right eye.

As shown in FIG. 1, the control unit 120 includes a rate control unit 121 and a judgment unit 122.

When the judgment unit 122 judges that disparity compensation should be performed in the coding of the second image, the rate control unit 121 determines the quantization step size to be applied to the second image to be a value that is smaller than the quantization step size to be applied to the first image. Specifically, the rate control unit 121 controls the bit rate of the bitstream by determining the quantization step size in the quantization, based on the amount of code that is generated in the coding of the first viewpoint video and the second viewpoint video by the coding processing unit 110.

For example, when the judgment unit 122 judges to use disparity compensation in the coding of the second image, the rate control unit 121 determines the quantization parameter to be used in the quantization of the second image to be a value that is smaller than the quantization parameter to be used in the quantization of the first image. Adjusting the value of the quantization parameter allows the value of the quantization step size to be adjusted.

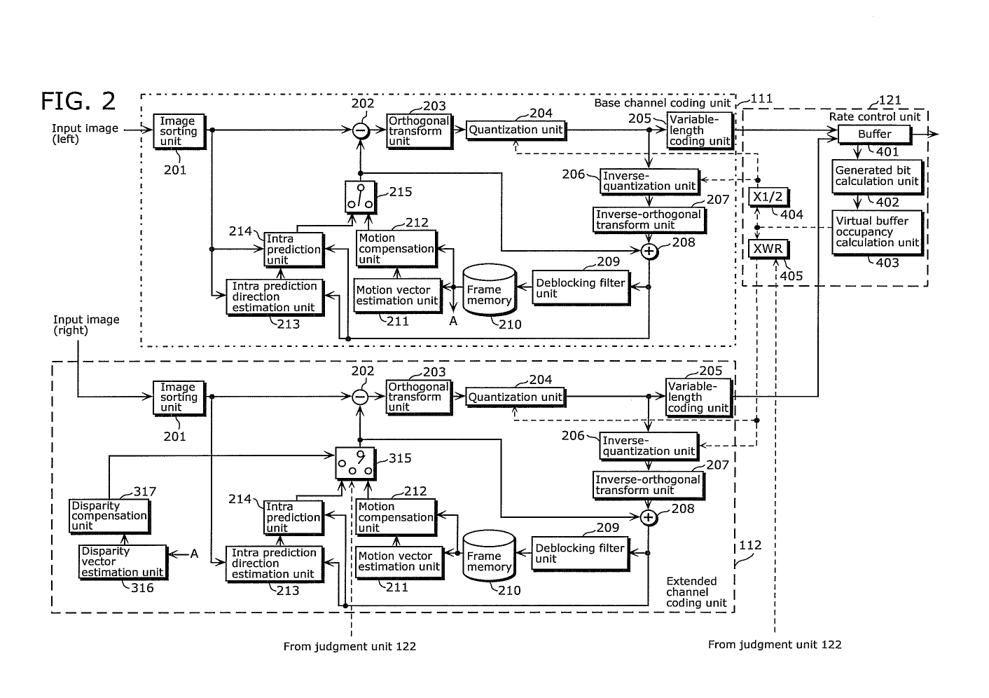

The detailed configuration and operation of the base channel coding unit 111, the extended channel coding unit 112, and the rate control unit 121 shall be described later using FIG. 2.

The judgment unit 122 judges which one to select between a prediction image generated through the application of motion compensation to a picture included in the second viewpoint video and a prediction image generated through the application of disparity compensation to a picture included in the second viewpoint video.

In addition, by notifying the judgment result to a selection unit 315 included in the extended channel coding unit 112, the judgment unit 122 causes the selection unit 315 to select and output one out of the prediction image generated through the application of motion compensation and the prediction image generated through the application of disparity compensation.

Specifically, the combination of the judgment unit 122 and the selection unit 315 is an example of the judgment unit of the stereo video coding apparatus according to an aspect of the present invention.

Furthermore, the judgment unit 122 judges, on a picture basis, which between disparity compensation and motion compensation should be performed in the coding of the second viewpoint video. For example, the judgment unit 122 selects one disparity compensation and motion compensation, based on the correlation between the first picture included in the first viewpoint video and the second picture included in the second viewpoint video, or in other words, based on the similarity between the images.

Specifically, the judgment unit 122 selects the one of the compensation methods having the higher correlation, based on (i) the correlation value between the current picture to be coded and the first image which serves as the reference image in disparity compensation and (ii) the correlation value between the current picture to be coded and the second image which serves as the reference image in motion compensation, and instructs the selected compensation method to the extended channel coding unit 112.

Here, residual error after compensation is smaller when the correlation between the current picture to be coded and the reference image is high. In other words, according to the above-described selection method, it is possible to select a compensation method by which coding can be performed with a lesser amount of code.

Then, the judgment unit 122 outputs a signal indicating either disparity compensation or motion compensation to the extended channel coding unit 112 and the rate control unit 121.

FIG. 2 is a block diagram showing an example of details of the coding processing unit 110 and the control unit 120 of the stereo video coding apparatus 100 according to Embodiment 1.

First, the base channel coding unit 111 shall be described. The base channel coding unit 111 codes the first viewpoint video which is the base channel video. Specifically, as shown in FIG. 2, a base channel input image (left-eye image) is inputted to the base channel coding unit 111.

The base channel coding unit 111 includes, an image sorting unit 201, a subtractor 202, an orthogonal transform unit 203, a quantization unit 204, a variable-length coding unit 205, an inverse-quantization unit 206, an inverse-orthogonal transform unit 207, an adder 208, a deblocking filter unit 209, a frame memory 210, a motion vector estimation unit 211, a motion compensation unit 212, an intra prediction direction estimation unit 213, an intra prediction unit 214, and a selection unit 215.

The image sorting unit 201 sorts, according to the frame order in the coding order, an image signal (first viewpoint video) inputted to the base channel coding unit 111, and in addition, partitions the sorted image signals into the units of coding, and outputs the result.

When a luminance signal is to be coded for example, the image sorting unit 201 sorts the luminance signal according to the frame order in the coding order, partitions the sorted luminance signal into macroblock—(hereafter denoted as “MB”) units of 16×16 pixels, and outputs the partitioned luminance signal to the subtractor 202, the intra prediction unit 214, and the intra prediction direction estimation unit 213.

The subtractor 202 generates a residual MB by calculating a difference between the current MB output by the image sorting unit 201 and a prediction MB which is generated by the intra prediction unit 214 or the motion compensation unit 212 and output by the selection unit 215. Subsequently, the subtractor 202 outputs the generated residual MB to the orthogonal transform unit 203.

The orthogonal transform unit 203 generates an orthogonal transform (hereafter called DCT) coefficient by performing orthogonal transform on the residual MB output by the subtractor 202. Then the orthogonal transform unit 203 outputs the DCT coefficient to the quantization unit 204.

The quantization unit 204 divides the DCT coefficient output by the orthogonal transform unit 203 using a quantization step size. Here, the quantization step size is an example of a quantization step size that is determined by the rate control unit 121, and is calculated by multiplying a coefficient value of a quantization matrix defined by the respective positions of orthogonal transform coefficients and the quantization parameter set by the rate control unit 121. In addition, the quantization unit 204 generates a quantized coefficient by rounding-off the result of the division into an integer value, and outputs the generated quantized coefficient to the variable-length coding unit 205 and the inverse-quantization unit 206.

The variable-length coding unit 205 generates the base channel bitstream (coding result of the left eye image) by performing variable-length coding (for example, arithmetic coding) on the quantized coefficient expressed by multi-value data and output by the quantization unit 204. Then, the variable-length coding unit 205 outputs the generated bitstream to the rate control unit 121.

The inverse-quantization unit 206 restores the quantized coefficient output by the quantization unit 204 to a DCT coefficient, by performing inverse-quantization on the quantized coefficient. Then the inverse-quantization unit 206 outputs the restored DCT coefficient to the inverse-orthogonal transform unit 207.

The inverse-orthogonal transform unit 207 restores the residual MB by performing inverse orthogonal transform on the DCT coefficient output by the inverse-quantization unit 206. Then, the inverse-orthogonal transform unit 207 outputs the restored residual MB to the adder 208.

The adder 208 generates a decoded MB by adding the residual MB output by the inverse-orthogonal transform unit 207 and the prediction MB generated by the intra prediction unit 214 or the motion compensation unit 212, which is output by the selection unit 215. Then, the adder 208 outputs the generated decoded MB to the deblocking filter unit 209, the intra prediction direction estimation unit 213, and the intra prediction unit 214.

The deblocking filter unit 209 performs deblocking filtering on the MB boundaries in the decoded MBs output by the adder 208. Then the deblocking filter unit 209 outputs the deblocking-filtered decoded MB to the frame memory 210.

The frame memory 210 is a memory for accumulating the decoded MBs output by deblocking filter unit 209. The frame memory 210 is configured of a recording-capable element such as a flash memory, a DRAM (Dynamic Random Access Memory), a ferroelectric memory, and so on.

The motion vector estimation unit 211 estimates the motion vector for the decoded MB accumulated in the frame memory 210, based on the current MB to be coded. It should be noted that, in the case of the H.264 standard, seven types of MB sizes are defined for the processing size of the MB to be processed by the motion vector estimation unit 211. The motion vector estimation unit 211 selects, for each MB, one size from these seven types.

The motion compensation unit 212 generates a prediction MB by performing motion compensation on the decoded MB accumulated in the frame memory 210, based on the motion vector estimated by the motion vector estimation unit 211 Subsequently, the motion compensation unit 212 outputs the generated prediction MB to the selection unit 215.

The intra prediction direction estimation unit 213 estimates the prediction mode to be applied in the intra prediction, based on the decoded MB output by the adder 208 and the current MB to be coded which is output by the image sorting unit 201. Then, the intra prediction direction estimation unit 213 outputs the estimated prediction mode to the intra prediction unit 214.

The intra prediction unit 214 generates a prediction MB by performing intra prediction on the decoded MB output by the adder 208. Then, the intra prediction unit 214 outputs the generated prediction MB to the selection unit 215.

The selection unit 215 selects one prediction MB out of the prediction MBs output respectively by the intra prediction unit 214 and the motion compensation unit 212, and outputs the selected prediction MB to the subtractor 202. For example, the selection unit 215 selects the prediction MB that yields a smaller sum of absolute differences (SAD) between the current MB and such prediction MB.

As described above, the base channel coding unit 111 codes the first viewpoint video which is a base channel video, by performing intra prediction or motion compensation, and quantization. The base channel bitstream generated by the coding is output to the rate control unit 121.

Next, the extended channel coding unit 112 shall be described.

The extended channel coding unit 112 codes the second viewpoint video which is the extended channel video. Specifically, as shown in FIG. 2, an extended channel input image (right-eye image) is inputted to the extended channel coding unit 112.

The extended channel coding unit 112 includes, an image sorting unit 201, a subtractor 202, an orthogonal transform unit 203, a quantization unit 204, a variable-length coding unit 205, an inverse-quantization unit 206, an inverse-orthogonal transform unit 207, an adder 208, a deblocking filter unit 209, a frame memory 210, a motion vector estimation unit 211, a motion compensation unit 212, an intra prediction direction estimation unit 213, an intra prediction unit 214, and a selection unit 315, a disparity vector estimation unit 316, and a disparity compensation unit 317.

In the extended channel, it is possible to perform coding using, aside from motion compensation, disparity compensation in which the base channel image is referred to. Therefore, the extended channel coding unit 112 adopts a configuration in which part of the base channel coding unit 111 is changed. Specifically, as shown in FIG. 2, the extended channel coding unit 112 is different compared to the base channel coding unit 111 in including the selection unit 315 in place of the selection unit 215, and further including the disparity vector estimation unit 316 and the disparity compensation unit 317. Aside from these differences, the extended channel coding unit 112 has the same configuration as the base channel coding unit 111. Description of points which are the same as in the base channel coding unit 111 shall be omitted, and the description hereinafter shall be focused on the points of difference.

The selection unit 315 selects one from among the prediction MBs output respectively by the intra prediction unit 214, the motion compensation unit 212, and the disparity compensation unit 317. Then, the selection unit 315 outputs the selected prediction MB to the subtractor 202 and the adder 208.

Specifically, the selection unit 315 selects one of disparity compensation and motion compensation, according to a signal from an outside source. More specifically, when disparity compensation is selected by the judgment unit 122, the selection unit 315 selects the prediction MB generated by the disparity compensation unit 317. When motion compensation is selected by the judgment unit 122, the selection unit 315 selects the prediction MB generated by the motion compensation unit 212.

In addition, the selection unit 315 selects either the prediction MB from the selected disparity compensation or motion compensation, or the prediction MB generated by the intra prediction unit 214. For example, the selection unit 315 selects, from between the two prediction MBs, the prediction MB that yields a smaller prediction error. Specifically, the selection unit 315 selects the one of the prediction MBs that has a sum of absolute differences between it and the current MB that is smaller than that of the other.

The disparity vector estimation unit 316 has, as input, the image held in the frame memory 210 (the frame memory 210 provided to the base channel coding unit 111) which accumulates a base channel decoded image (A in the middle of the figure), and, in addition, the disparity vector estimation unit 316 calculates a disparity vector using the input image for the right eye which is inputted from the image sorting unit 201. Then, the disparity vector estimation unit 316 outputs the calculated disparity vector to the disparity compensation unit 317.

The disparity compensation unit 317 generates a prediction MB by performing disparity compensation on the decoded image accumulated in the base channel frame memory 210, based on the disparity vector estimated by the disparity vector estimation unit 316. Subsequently, the disparity compensation unit 317 outputs the generated prediction MB to the selection unit 315.

As described above, the extended channel coding unit 112 codes the second viewpoint video which is an extended channel video, by performing intra prediction, motion compensation or disparity compensation, and quantization. The extended channel bitstream generated by the coding is output to the rate control unit 121.

Next, the rate control unit 121 shall be described. The rate control unit 121 includes a buffer 401, a generated bit calculation unit 402, a virtual buffer occupancy calculation unit 403, a ½ multiplier 404, and a WR multiplier 405.

The buffer 401 receives the extended channel bitstream and the base channel bitstream from the extended channel coding unit 111 and the base channel coding unit 112, respectively, and multiplexes and outputs the two received bitstreams.

The generated bit calculation unit 402 counts the amount of bits generated from the start of the coding of a picture, based on information from the buffer 401 (for example, the amount of bits accumulated in the buffer 401).

The virtual buffer occupancy calculation unit 403 calculates the virtual buffer occupancy d, according to the previously described (Equation 1).

The ½ multiplier 404 calculates the dL to be used in the quantization of the left-eye image which is the base channel, according to (Equation 2) and using the value calculated according to (Equation 1). In addition, the rate control unit 121 calculates the quantization parameter mquant by performing computations according to (Equation 3) to (Equation 6), and outputs the calculated mquant to the base channel coding unit 111. As described above, the quantization parameter mquant calculated according to (Equation 2) to (Equation 6) is used in the quantization of the left-eye image.

The WR multiplier 405 calculates the dR to be used in the quantization of the right-eye image which is the extended channel, according to (Equation 9) below and using the value calculated according to (Equation 1).

dR=(WR)×d (Equation 9)

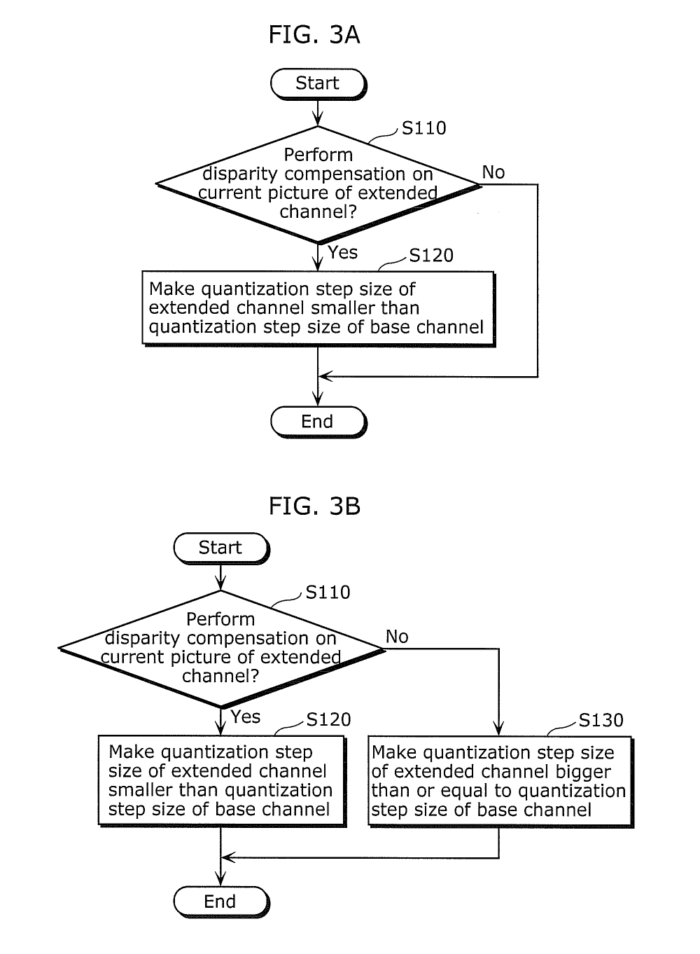

Here, WR is a parameter that is determined depending on which between disparity compensation and motion compensation is to be performed in the extended channel coding unit 112. In addition, the WR multiplier 405 calculates the quantization parameter mquant according to previously described (Equation 8), (Equation 3), (Equation 5), and (Equation 6), and outputs the calculated mquant to the extended channel coding unit 112. It should be noted that the specific operation of the WR multiplier 405 shall be described later using FIG. 3.

As described above, the quantization parameter mquant calculated according to (Equation 8), (Equation 3), (Equation 5), and (Equation 6) is used in the quantization of the right-eye image.

Hereinafter, the operations for determining the quantization step size of the extended channel in the stereo video coding apparatus 100 according to Embodiment 1 shall be described using FIG. 3A and FIG. 3B.

FIG. 3A is a flowchart showing an example of basic operations of the stereo video coding apparatus 100 according to Embodiment 1.

It should be noted that the basic operations shown in FIG. 3A are also executed, in common, in the stereo video coding apparatuses 500 and 800 according to Embodiments 2 and 3 to be described later.

First, the judgment unit 122 judges whether or not disparity compensation should be performed on the current picture of the extended channel (S110). For example, the judgment unit 122 calculates a correlation value C1 between the input image for the right eye which is the extended channel and the current image to be coded. The judgment unit 122 further calculates a correlation value C2 between the input image for the left eye which is the base channel and the current image to be coded.

The judgment unit 122 judges, based on the correlation value C1 and the correlation value C2, which between disparity compensation and motion compensation is the prediction method that will yield a smaller amount of code. For example, when the correlation value C2 is larger than the correlation value C1, using disparity compensation which uses the base channel image yields a smaller amount of code than motion compensation which uses the extended channel image. As such, the judgment unit 122 selects disparity compensation.

When the judgment unit 122 judges that disparity compensation should be used (Yes in S110), the rate control unit 121 makes the quantization step size for the extended channel smaller than the quantization step size for the base channel (S120). Specifically, the WR multiplier 405 calculates dR according to (Equation 9), using a value such that WR<(½).

For example, when a value that is less than ½ and a value that is equal to or greater than ½ are predetermined as values of WR, and the WR multiplier 405 receives a signal indicating disparity compensation from the judgment unit 122, the WR multiplier 405 selects and uses the value that is less than ½.

It should be noted that, when the judgment unit 122 judges that motion compensation should be used (No in S110), the rate control unit 121 can, for example, determine each of the quantization step size for the base channel and the quantization step size for the extended channel independently of each other.

In the present embodiment, when the judgment unit 122 judges that motion compensation should be used (No in S110), the rate control unit 121 determines the quantization step size for the extended channel, as shown in FIG. 3B.

FIG. 3B is a flowchart showing an example of operations of the stereo video coding apparatus 100 according to Embodiment 1.

Specifically, when the judgment unit 122 judges that motion compensation should be performed (No in S110), the rate control unit 121 makes the quantization step size of the extended channel bigger than or the same as the quantization step size for the base channel (S130). The WR multiplier 405 calculates dR using a value such that WR≧(½). For example, when the WR multiplier 405 receives a signal indicating motion compensation from the judgment unit 122, the WR multiplier 405 selects and uses the value that is equal to or greater than ½.

The multiplier WR (<(½)) for the virtual buffer occupancy d when coding the extended channel by performing disparity compensation is less than ½ which is the multiplier for the base channel. As such, according to the functions in (Equation 3), (Equation 4), and so on, the quantization parameter of the extended channel becomes a value smaller than the quantization parameter of the base channel. As a result, a sufficiently small quantization parameter can be used in the quantization of the extended channel, and with this, the problem of the occurrence of ringing can be solved.

It should be noted that, since a small quantization parameter is used on the entire screen, in other words, on a picture basis, in Embodiment 1, it is considered that the amount of code will increase significantly. However, in actuality, error is almost zero in the disparity-less region occupying the majority of the screen. As such, the increase in the amount of code in a region with little disparity due to the use of a small quantization parameter is not big. In particular, since error becomes zero in images for animation, and so on, the increase in the amount of code is used only in improving an area in which conventional ringing, and so on, has occurred.

As described above, the stereo video coding apparatus 100 according to Embodiment 1 judges, on a picture basis, which between disparity compensation and motion compensation should be performed when coding an extended channel video. Then, when disparity compensation is to be performed, the stereo video coding apparatus 100 performs the quantization of the extended channel using a quantization step size that is smaller than the quantization step size for the base channel.

With this, deterioration of picture quality can be reduced by suppressing the coding distortion occurring in the extended channel during the coding of the stereo video. Specifically, it is possible to eliminate the ringing that occurs when the residual component that is created due to the absence of a pixel corresponding to a current pixel to be decoded is quantized using an inappropriate quantization step size.

Therefore, it is possible to generate coded data of higher-quality stereo video that is free from the subjectively undesirable noise appearing only on one of stereoscopic images particularly when disparity compensation is performed. Furthermore, since the increase in the amount of code due to the use of a small quantization step size is extremely small, it is possible to improve picture quality with a minimal increase in the amount of code. It should be noted that the above-described advantageous effect is produced further when the bit rate is high.

It should be noted that although Embodiment 1 describes an example in which the rate control unit 121 uses a rate control method that is based on the virtual buffer occupancy d, the quantization parameter may be determined according to another rate control method.

As a rate control method other than the method described above, instead of multiplying the virtual buffer occupancy d by WR<(½), and so on, a method of multiplying the determined quantization parameter by a coefficient shall be given as an example. Specifically, it is sufficient to multiply the determined quantization parameter by ½ times for the base channel and by WR (<(½)) times for the extended channel.

In other words, any method can be used as long as the quantization step size to be applied to the extended channel becomes smaller than the quantization step size to be applied to the base channel when disparity compensation is to be performed on the extended channel.

### Embodiment 2

The stereo video coding apparatus according to Embodiment 2 of the present invention is characterized by switching between disparity compensation and motion compensation, not on a picture basis, but in units of small regions each of which is a part of a picture.

The small region is for example a macroblock, and, specifically, in the stereo video coding apparatus according to Embodiment 2, the coding processing unit determines which between disparity compensation and motion compensation should be performed, on a small region basis. In addition, stereo video coding apparatus according to Embodiment 2 of the present invention is characterized in that, when it is determined that disparity compensation should be performed, the control unit determines the quantization step size to be applied to the second image which is the image of a small region of a second picture (extended channel) to be a value smaller than the quantization step size to be applied to the first image which is the image of a small region of a first picture (base picture).

Specifically, in Embodiment 2, the first image is an image making up a part (for example, an MB) of the first picture included in the first viewpoint video, and the second image is an image making up a part of the second picture included in the second viewpoint video.

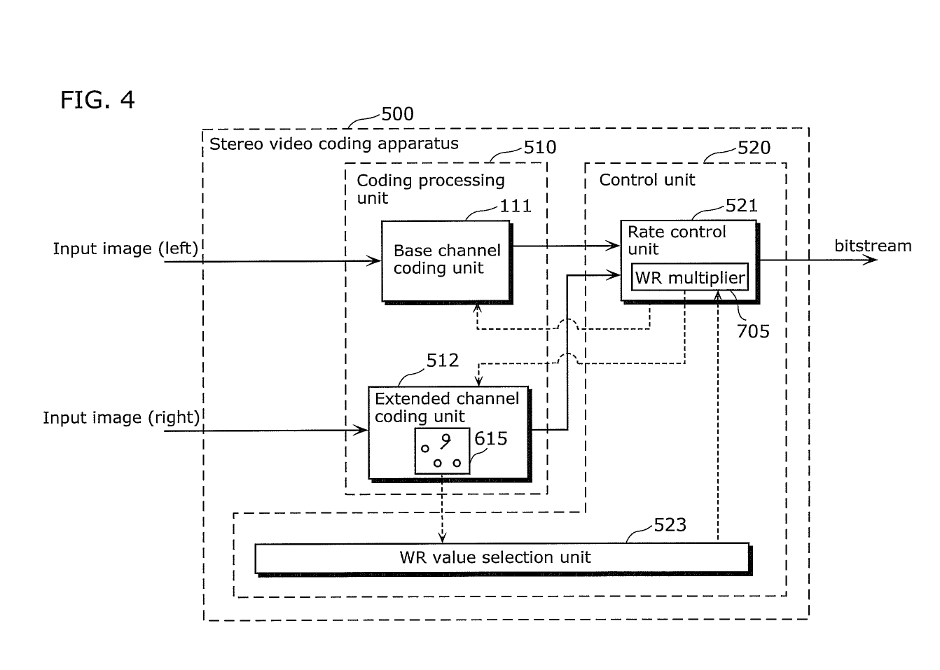

FIG. 4 is a block diagram showing an example of a configuration of the stereo video coding apparatus 500 according to Embodiment 2.

In the same manner as the stereo video coding apparatus 100 according to Embodiment 1, the stereo video coding apparatus 500 codes the first viewpoint video (base channel) of the first viewpoint and the second viewpoint video (extended channel) of the second viewpoint that are to be used in stereoscopic viewing. As shown in FIG. 4, the stereo video coding apparatus 500 includes a coding processing unit 510 and a control unit 520.

The coding processing unit 510 codes the first viewpoint video and the second viewpoint video by performing intra prediction, motion compensation or disparity compensation, and quantization. As shown in FIG. 4, the coding processing unit 510 includes the base channel coding unit 111, and an extended channel coding unit 512. It should be noted that the same reference signs are assigned to constituent elements that are the same as those in Embodiment 1, and detailed description thereof shall not be repeated here.

The base channel coding unit 111 is the same as that in Embodiment 1, and codes the base channel video, that is, the first viewpoint video (for example, a video for the left eye).

The extended channel coding unit 512 codes the extended channel video, that is, the second viewpoint video (for example, a video for the right eye). The extended channel coding unit 512 according to Embodiment 2 is different compared to the extended channel coding unit 112 according to Embodiment 1 in including a selection unit 615 in place of the selection unit 315. Since the other constituent elements are the same as the constituent elements shown in FIG. 2, their description shall not be repeated here (also not shown in FIG. 4).

The selection unit 615 determines which among intra prediction, motion compensation, and disparity compensation should be performed in coding the second image which is a part of the second picture of the extended channel. Specifically, the selection unit 615 selects one from among the prediction MBs output respectively by the intra prediction unit 214, the motion compensation unit 212, and the disparity compensation unit 317.

For example, the selection unit 615 selects the prediction MB with which the amount of code generated in the coding of the prediction error is the smallest. This can be implemented, for example, by selecting the prediction MB which yields the smallest sum of absolute differences of values of pixels inside the prediction error MB. Then the selection unit 615 outputs, to the control unit 520, a signal indicating which prediction method was selected among the three prediction methods (intra prediction, motion compensation, and disparity compensation).

When the coding processing unit 510 determines to use disparity compensation in coding the second image, the control unit 520 determines the quantization step size to be applied to the second image to be a value smaller than the quantization step size to be applied to the first image. It should be noted that the first image is a part of the first picture of the base channel, and is an image that is a pair with the second image. For example, the first image is an image captured at the same image-capturing time as the second image.

As shown in FIG. 4, the control unit 520 includes a rate control unit 521 and a WR value selection unit 523.

The WR value selection unit 523 selects the WR value for each unit of processing for which the coding processing unit 510 selects disparity compensation or motion compensation, and outputs the selected WR value to a WR multiplier 705. For example, the WR value selection unit 523 outputs, for each macroblock, (i) a value such that WR<(½), in the case where disparity compensation is selected by the selection unit 615, and (ii) a value such that WR≧(½), in all other cases.

When the coding processing unit 510 determines to use disparity compensation, the rate control unit 521 determines the quantization step size to be applied to the second image to be a value smaller than the quantization step size to be applied to the first image. The rate control unit 512 according to embodiment 2 is different compared to the rate control unit 121 according to Embodiment 1 in including the WR multiplier 705 in place of the WR multiplier 405. Since the other constituent elements are the same as the constituent elements shown in FIG. 2, their description shall not be repeated here (also not shown in FIG. 4).

The WR multiplier 705 determines the quantization parameter mquant by performing the same operation as in Embodiment 1, according to (Equation 9), and using the WR from the WR value selection unit 523. At this time, the WR multiplier 705 calculates the quantization parameter mquant for each macroblock since the WR is different for each macroblock.

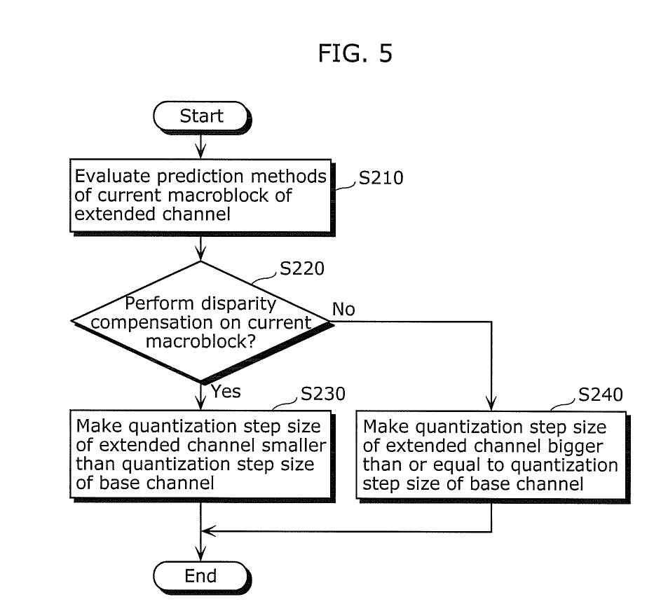

Hereinafter, details of an example of the operations for determining the quantization step size of the extended channel in the stereo video coding apparatus 500 according to Embodiment 2 shall be described using FIG. 5.

FIG. 5 is a flowchart showing an example of operations of the stereo video coding apparatus 500 according to Embodiment 2.

First, the extended channel coding unit 512 evaluates the prediction methods for the current MB of the extended channel (S210). Specifically, the selection unit 615 selects, from among intra prediction, motion compensation, and disparity compensation, the prediction method for generating a prediction MB having the smallest prediction error. The selection unit 615 outputs a signal indicating the selected prediction method to the WR value selection unit 523.

At this time, when disparity compensation is selected by the selection unit 615 (Yes in S220), the control unit 520 makes the quantization step size for the extended channel smaller than the quantization step size for the base channel (S230). Specifically, when the WR value selection unit 523 receives a signal indicating disparity compensation, the WR value selection unit 523 outputs a WR value which is less than ½ to the WR multiplier 705.

Furthermore, when disparity compensation is not selected by the selection unit 615 (No in S220), in the present embodiment, the control unit 520 makes the quantization step size for the extended channel bigger than or equal to the quantization step size for the base channel (S240). For example, when the WR value selection unit 523 receives a signal indicating motion compensation, the WR value selection unit 523 outputs a WR value which is equal to or greater than ½ to the WR multiplier 705.

It should be noted that the WR value selection unit 523 holds, for example, a value that is less than ½ and a value that is equal to or greater than ½ before hand, and, upon receiving a signal indicating disparity compensation, outputs, as the WR value, the value which is less than ½ to the WR multiplier 705.

With the above-described configuration, the stereo video coding apparatus 500 according to Embodiment 2 determines whether or not disparity compensation is to be performed, in units of small regions each of which is a part of a picture. Then, when disparity compensation is to be performed, the stereo video coding apparatus 500 performs the quantization of the extended channel using a quantization step size that is smaller than the quantization step size for the base channel.

With this, even when a block to be motion compensated and a block to be disparity compensated are present together in a picture, it is possible to make the quantization step size to be used in the extended channel smaller than the quantization step size to be used in the base channel, only for the block on which disparity compensation is to be performed. Therefore, the occurrence of ringing can be suppressed, and thus it is possible to reduce the deterioration of picture quality.

It should be noted that, according to the stereo video coding apparatus 500 according to Embodiment 2, regions on which a small quantization step size is to be used are reduced more than when a small quantization step size is used on the entire screen, and thus coding efficiency can be further improved.

It should be noted that although the small region is assumed to be a macroblock in Embodiment 2, the small region is not limited to such. For example, the small region can also be a slice.

### Embodiment 3

The stereo video coding apparatus according to Embodiment 3 of the present invention is characterized by determining the quantization step size to be applied to the second image, based on a scalar amount indicating features of a difference image which is the difference between a prediction image generated by disparity compensation and the second image.

In essence, the stereo video coding apparatus according to Embodiment 3 is characterized by using a variable value as the quantization step size to be applied to the second image, instead of a fixed value that is smaller than the quantization step size to be applied to the first image.

It should be noted that, in Embodiment 3, the first image is an image making up a part (for example, an MB) of the first picture included in the first viewpoint video, and the second image is an image making up a part of the second picture included in the second viewpoint video.

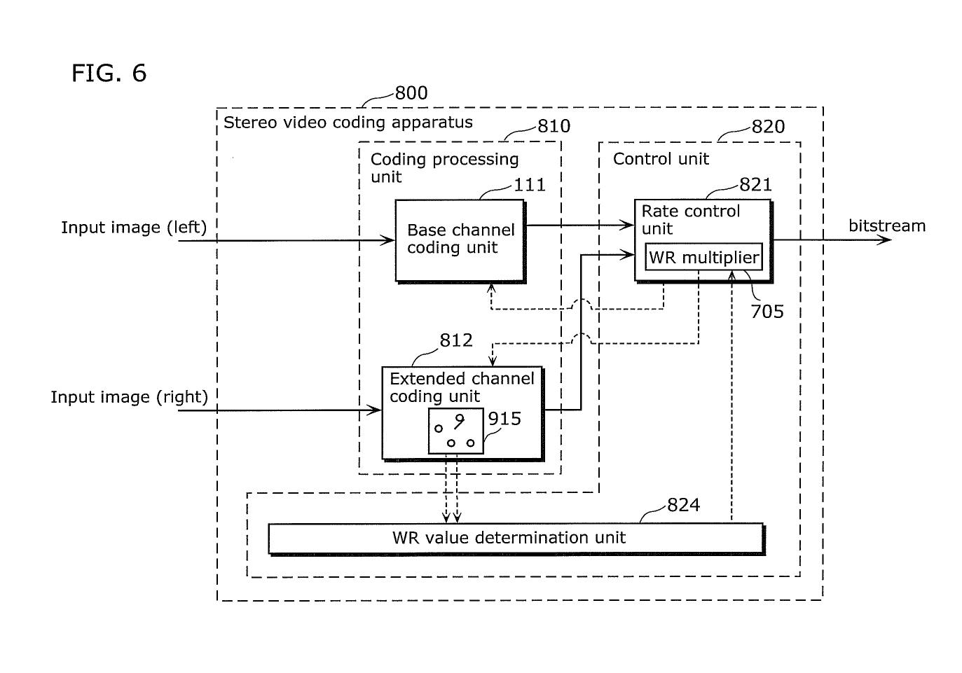

FIG. 6 is a block diagram showing an example of a configuration of the stereo video coding apparatus 800 according to Embodiment 3. In the same manner as the stereo video coding apparatus 500 according to Embodiment 2, the stereo video coding apparatus 800 codes the first viewpoint video (base channel) of the first viewpoint and the second viewpoint video (extended channel) of the second viewpoint that are to be used in stereoscopic viewing. As shown in FIG. 6, the stereo video coding apparatus 800 includes a coding processing unit 810 and a control unit 820.

The coding processing unit 810 codes the first viewpoint video and the second viewpoint video by performing intra prediction, motion compensation or disparity compensation, and quantization. As shown in FIG. 6, the coding processing unit 810 includes the base channel coding unit 111, and an extended channel coding unit 812. It should be noted that the same reference signs are assigned to constituent elements that are the same as those in Embodiments 1 and 2, and detailed description thereof shall not be repeated here.

The base channel coding unit 111 is the same as those in Embodiments 1 and 2, and codes the base channel video, that is, the first viewpoint video (for example, a video for the left eye).

The extended channel coding unit 812 codes the extended channel video, that is, the second viewpoint video (for example, a video for the right eye). The extended channel coding unit 812 according to Embodiment 3 is different compared to the extended channel coding unit 512 according to Embodiment 2 in including a selection unit 915 in place of the selection unit 615. Since the other constituent elements are the same as the constituent elements shown in FIG. 2, their description shall not be repeated here (also not shown in FIG. 6).

In the same manner as the selection unit 615, the selection unit 915 determines which among intra prediction, motion compensation, and disparity compensation should be used in the coding of the second image which is a part of the second picture of the extended channel. Specifically, the selection unit 915 selects, for each macroblock, the prediction MB that yields the least amount of code, among a disparity compensation MB, an intra prediction MB, and a motion compensation MB. Then, the selection unit 915 outputs a signal indicating the selected prediction method.

In addition, when the selection unit 915 selects the disparity compensation MB, the selection unit 915 outputs a scalar amount indicating the features of the difference image which is the difference between the prediction image generated by disparity compensation and the second image.

In other words, the selection unit 915 functions as a scalar amount calculation unit. Specifically, the selection unit 915 simultaneously outputs a scalar amount representing the size of the amount of code at the time when the residual image is coded. For example, the larger the scalar amount the larger the amount of code generated in the coding of the residual image, and the smaller the scalar amount the smaller the amount of code generated in the coding of the residual image.

For example, the selection unit 915 may output, as the scalar amount, the amount of code when orthogonal transform, quantization, and variable-length coding are actually performed on the residual error between the disparity compensation MB and the current MB to be coded. Furthermore, the amount of processing may be reduced by simplifying the quantization and the variable-length coding. Furthermore, for example, the sum of absolute values of residual pixels or the sum of absolute values of transform coefficients after orthogonal transform may be output as the scalar amount.

Furthermore, although, in normal quantization, the quantization step size is different for each orthogonal transform coefficient due to the use of a quantization matrix, quantization may be performed using a single quantization step size by assuming a uniform quantization matrix. In this case, by calculating the sum of absolute differences of values prior to quantization, and dividing the result by the quantization step size, the number of iterations for the dividing operation can be significantly reduced.

When the coding processing unit 810 determines to use disparity compensation in coding the second image, the control unit 820 determines the quantization step size to be applied to the second image to be a value smaller than the quantization step size to be applied to the first image. It should be noted that the first image is a part of the first picture of the base channel, and is an image that is a pair with the second image.

As shown in FIG. 6, the control unit 820 includes a rate control unit 821 and a WR value determination unit 824.

When the coding processing unit 810 determines to use disparity compensation, the WR value determination unit 824 determines the quantization step size to be applied to the second image, based on the scalar amount output by the coding processing unit 810. Specifically, when disparity compensation is selected, the WR value determination unit 824 determines the value of WR based on the scalar amount output by the selection unit 915.

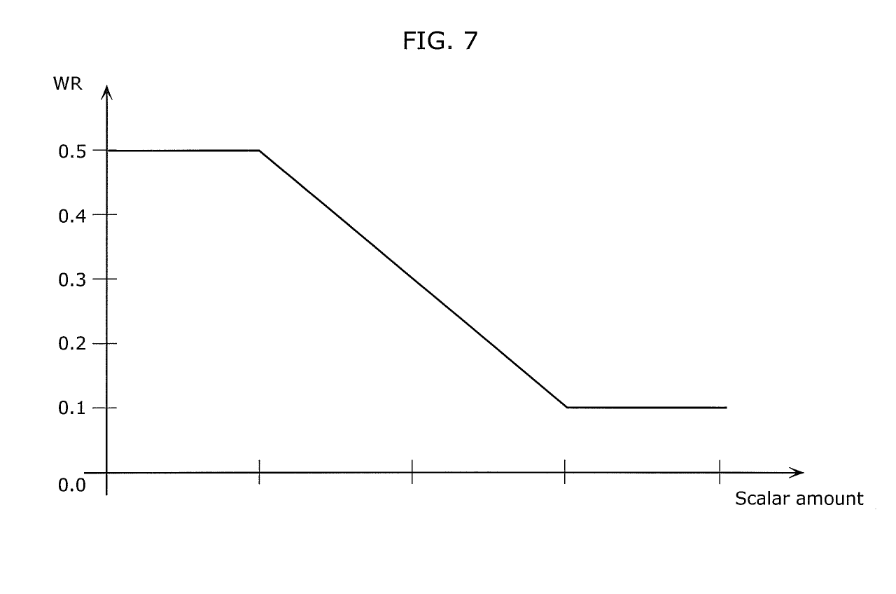

The WR value determination unit 824 may, for example, determine the value of WR based on a broken curve graph, such as that shown in FIG. 7, which monotonically decreases with respect to the scalar amount. Specifically, the WR value determination unit 824 determines the WR value such that, the larger the scalar amount, the smaller the value. Stated differently, the WR value determination unit 824 determines the value of the quantization step size to be applied to the second image of the extended channel such that, the larger the scalar amount, the smaller the value.

Here, generally, when the scalar amount is large, the amount of code generated in the coding of the residual image is large, and as a result, the ringing noise, and so on, becomes more noticeable. However, in the stereo video coding apparatus 800 according to the present embodiment, a quantization step size having a small value is used when the scalar amount is large, and thus the occurrence of ringing can be suppressed.

The WR multiplier 705 included in the rate control unit 821 determines the quantization parameter mquant, in the same manner as in Embodiments 1 and 2, using the WR determined by the WR value determination unit 824. It should be noted that since the other constituent elements included in the rate control unit 821 are the same as those in Embodiments 1 and 2, their description shall not be repeated here (also not shown in FIG. 6).

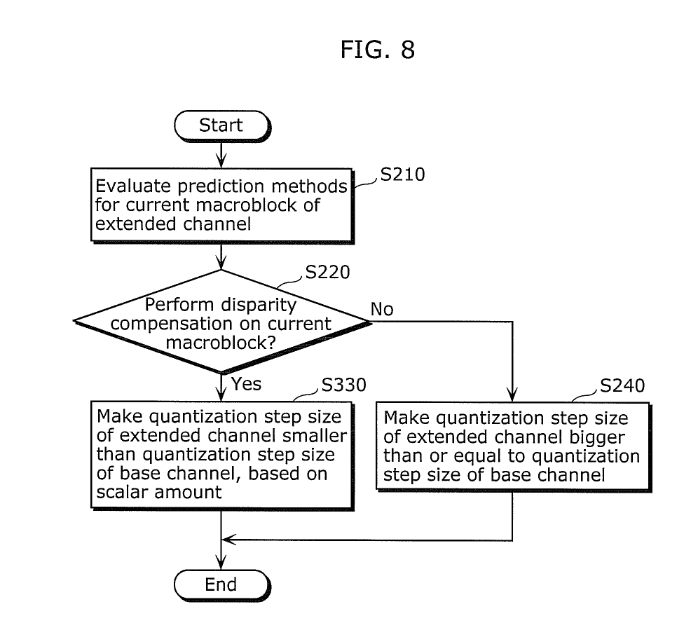

Hereinafter, details of an example of the operations for determining the quantization step size of the extended channel in the stereo video coding apparatus 800 according to Embodiment 3 shall be described using FIG. 8.

FIG. 8 is a flowchart showing an example of operations of the stereo video coding apparatus 800 according to Embodiment 3. It should be noted that the same reference signs are assigned to operations that are the same as in Embodiment 2, and their description shall not be repeated here.

When disparity compensation is selected by the selection unit 915 (Yes in S220), the control unit 820 makes the quantization step size of the extended channel smaller than the quantization step size of the base channel, based on the scalar amount output by the selection unit 915 (S330).

In other words, the control unit 820 determines the value of the quantization step size such that, the larger the scalar amount the smaller the value, and the smaller the scalar amount the larger the value. Specifically, the WR value determination unit 824, for example, determines the WR value according to the graph shown in FIG. 7. Then, the WR value determination unit 824 outputs the determined WR value to the WR multiplier 705, and the WR multiplier 705 calculates the quantization parameter mquant.

With the above-described configuration, the stereo video coding apparatus 800 according to Embodiment 3 determines the quantization step size to be applied to the second image, based on the scalar amount indicating the features of the difference image which is the difference between the prediction image generated by disparity compensation and the second image.

In essence, the stereo video coding apparatus according to Embodiment 3 uses, as the quantization step size to be applied to the second image, a variable value that is smaller than the quantization step size to be applied to the first image, instead of a fixed value that is smaller than the quantization step size to be applied to the first image.

Accordingly, quantization can be performed using a smaller quantization step size when it is expected that ringing will be more noticeable, and thus deterioration of picture quality can be further suppressed.

Although only some exemplary embodiments of this invention have been described in detail above, those skilled in the art will readily appreciate that many modifications are possible in the exemplary embodiments without materially departing from the novel teachings and advantages of this invention. Accordingly, all such modifications are intended to be included within the scope of this invention.

For example, whether or not to perform disparity compensation may be determined based on the disparity between the first image and the second image.

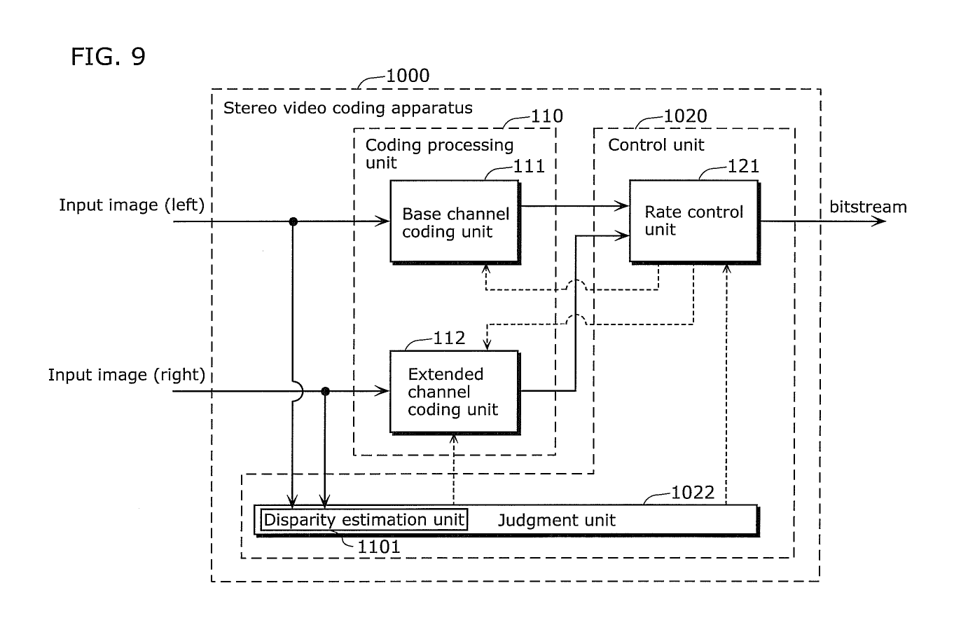

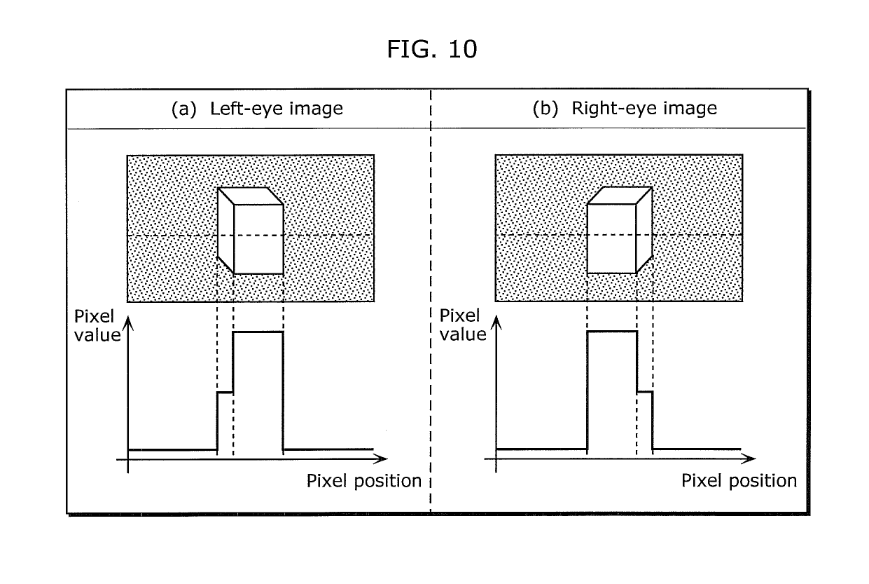

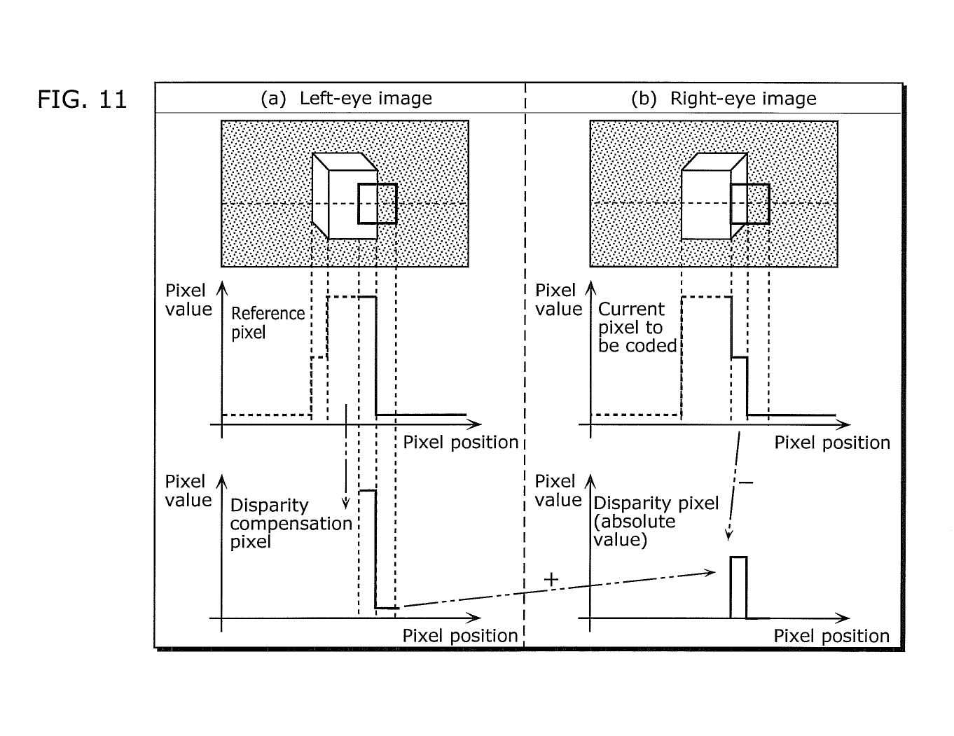

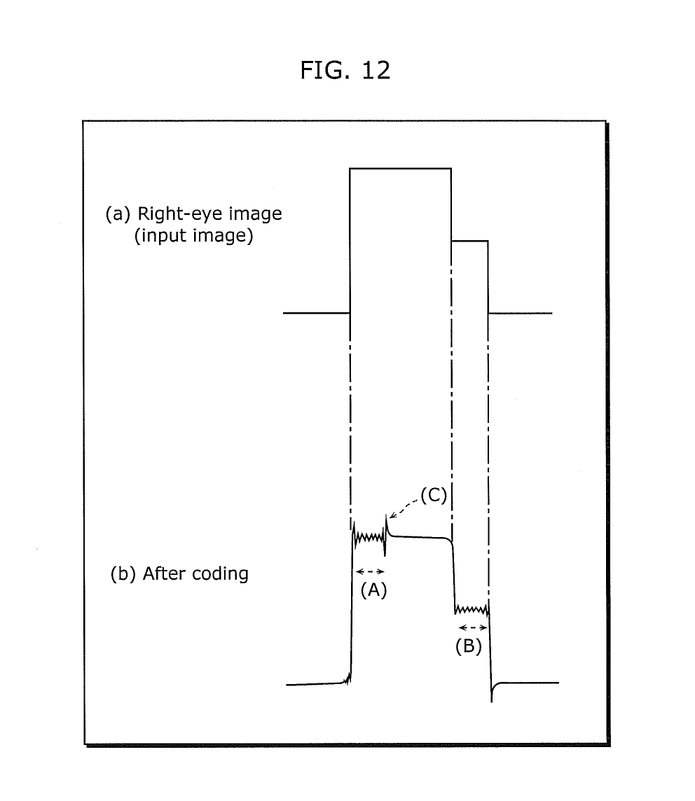

FIG. 9 is a block diagram showing an example of a configuration of a stereo video coding apparatus 1000 according to a modification of Embodiment 1. As shown in FIG. 9, the stereo video coding apparatus 1000 is different compared to the stereo video coding apparatus 100 according to Embodiment 1 in including a control unit 1020 in place of the control unit 120. Specifically, the control unit 1020 is different in including a judgment unit 1022 in place of the judgment unit 122.

The judgment unit 1022 judges, based on the disparity between the first image and the second image, whether or not disparity compensation should be performed in the coding of the second image of the extended channel. As shown in FIG. 9, the judgment unit 1022 includes a disparity estimation unit 1101.

The disparity estimation unit 1101 estimates the disparity between the first image of the base channel and the second image of the extended channel. For example, the disparity estimation unit 1101 obtains the first picture included in the first viewpoint video of the base channel and the second picture included in the second viewpoint video of the extended channel, and generates a disparity map. A disparity map indicates the disparity amount for each region (for example, MB) of the pair of current pictures (first picture and second picture).

The judgment unit 1022 judges whether or not the reliability of the disparity map generated by the disparity estimation unit 1101 is high. Then, the judgment unit 1022 judges that disparity compensation should be performed, when the reliability of the disparity map is higher than a predetermined threshold, and judges that motion compensation should be performed, when the reliability of the disparity map is lower than the threshold.

The reliability of the disparity map is determined, for example, based on the sum of absolute differences (SAD) between the first picture and the second picture. Specifically, the smaller the SAD, the higher the reliability of the disparity map, and the bigger the SAD, the lower the reliability of the disparity map. This is because, a small SAD means that the first picture and the second picture are similar, and thus means that there is a high probability that the disparity estimation is performed correctly.

It should be noted that the processes when one of disparity compensation and motion compensation are determined are the same as in the respective embodiments described above.

Furthermore, although the quantization step size which is a value determined by the multiplication of the quantization parameter and the quantization matrix is used as an example of the quantization step size in the respective embodiments described above, the quantization step size is not limited to such. A value determined by at least one of the quantization parameter and the quantization matrix may be used as the quantization step size.

For example, the value of the quantization matrix can be set on a picture or slice basis. Furthermore, the value of the quantization parameter can be set on a macroblock basis by setting the reference quantization parameter which serves as a reference, on a slice basis, and adjusting the reference quantization parameter on a macroblock basis.

Therefore, in the respective embodiments of the present invention, the reference quantization parameter may be changed on a picture or slice basis, and the amount adjusted from the reference quantization parameter may be changed on a macroblock basis. No matter which method is used, the quantization step size can be made small by making the value of the quantization parameter small.

Furthermore, although the value of the quantization step size is changed by changing the value of the quantization parameter in the respective embodiments described above, the quantization matrix may be changed. Specifically, when disparity compensation is to be performed in the coding of the second image, at least one of the coefficient values of the quantization matrix to be used in the quantization of the second image may be determined to be a value that is smaller than a coefficient value of the quantization matrix to be used in the quantization of the first image.

For example, when the judgment unit 122 judges that disparity compensation should be performed on the second picture in Embodiment 1, the rate control unit 121 may determine, as the quantization matrix to be used in the quantization of the second picture, a quantization matrix having smaller coefficient values than the quantization matrix to be used in the quantization of the first picture. At this time, all of the coefficient values of the quantization matrix need not be made small, and, for example, it is acceptable to make only the coefficient value of a low-frequency component or high-frequency component small.

Accordingly, since flexibility in the adjustment of the quantization step size can be increased, the prevention of picture quality deterioration and the improvement of coding efficiency can be realized.

Furthermore, the respective embodiments described above show an example of the stereo video which includes a first viewpoint video of the first viewpoint which is the base channel and a second viewpoint video of the second viewpoint which is the extended channel. However, the stereo video may include videos of plural extended channels.

It should be noted that, as described above, the present invention may be implemented, not only as a stereo video coding apparatus and a stereo video coding method, but also as a program which causes a computer to execute the stereo video coding method in the embodiments. Furthermore, the present invention may also be implemented as a computer-readable recording medium on which the program is recorded, such as a CD-ROM. Furthermore, the present invention may also be implemented as information, data, or a signal, which represents the program. In addition, such program, information, data and signal may be distributed via a communication network such as the Internet.

Furthermore, a part or all of the constituent elements making up the stereo video coding apparatus may be structured as a single system LSI. The system LSI is a super multi-functional LSI manufactured by integrating a plurality of structural units onto a single chip. Specifically, it is a computer system including a microprocessor, a ROM, a RAM, and the like.

### INDUSTRIAL APPLICABILITY

The stereo video coding apparatus according to the present invention produces the advantageous effect of being capable of reducing the deterioration of picture quality by suppressing coding distortion occurring in an extended channel during coding of a stereo video, and can be used in, for example, a digital television, a digital video recorder, a digital camera, and so on.

1. A stereo video coding apparatus which codes at least a second image included in a second viewpoint video out of a first viewpoint video of a first viewpoint and the second viewpoint video of a second viewpoint, the first viewpoint video and the second viewpoint video making up a video for stereoscopic viewing, said stereo video coding apparatus comprising:
a judgment unit configured to output one of a prediction image generated by applying motion compensation to a picture included in the second viewpoint video and a prediction image generated by applying disparity compensation to a picture included in the first viewpoint video, by selectively switching between the prediction images;
a subtractor which calculates a difference between the prediction image output by said judgment unit and the second image, to generate a residual component;
an orthogonal transform unit configured to perform orthogonal transform on the residual component generated by said subtractor, to generate an orthogonal transform coefficient;
a quantization unit configured to perform quantization on the orthogonal transform coefficient generated by said orthogonal transform unit, to generate a quantization coefficient; and
a control unit configured to determine a quantization step size to be used by said quantization unit,
wherein said control unit is configured to determine a quantization step size to be applied to the second image to be a value smaller than a quantization step size to be applied to a first image included in the first viewpoint video, when said judgment unit selects the prediction image generated by applying disparity compensation, the first image being paired with the second image.

2. The stereo video coding apparatus according to claim 1,
wherein said judgment unit is configured to judge, on a picture basis, which one of the prediction image generated by applying motion compensation and the prediction image generated by applying disparity compensation to select, and
said control unit includes
a rate control unit configured to determine the quantization step size to be applied to the second image to be a value smaller than the quantization step size to be applied to the first image, when said judgment unit selects the prediction image generated by applying disparity compensation.

3. The stereo video coding apparatus according to claim 1,
wherein the first image is an image that is part of a first picture included in the first viewpoint video,
the second image is an image that is part of a second picture included in the second viewpoint video,
said judgment unit is configured to judge which one of the prediction image generated by applying motion compensation and the prediction image generated by applying disparity compensation to select in the coding of the second picture, and
said control unit is configured to determine the quantization step size to be applied to the second image to be a value smaller than the quantization step size to be applied to the first image, when said judgment unit selects the prediction image generated by applying disparity compensation.

4. The stereo video coding apparatus according to claim 3, further comprising
a scalar amount calculation unit configured to, when said judgment unit selects the prediction image generated by applying disparity compensation, calculate a scalar amount indicating features of a difference image which is a difference between the selected prediction image and the second image,
wherein said control unit is further configured to determine the quantization step size to be applied to the second image, based on the scalar amount, when said judgment unit selects the prediction image generated by applying disparity compensation.

5. The stereo video coding apparatus according to claim 4,
wherein the scalar amount is a sum of absolute differences of the difference image, and
said judgment unit is configured to determine the quantization step size to be applied to the second image to be a smaller value when the scalar amount is larger.

6. The stereo video coding apparatus according to claim 1,
wherein the quantization step size is a value determined according to at least one of a quantization matrix and a quantization parameter, and
said control unit is configured to determine at least one of coefficient values of a quantization matrix to be used in quantization of the second image to be a value smaller than a coefficient value of a quantization matrix to be used in quantization of the first image, when said judgment unit selects the prediction image generated by applying disparity compensation.

7. The stereo video coding apparatus according to claim 1,
wherein the quantization step size is a value determined according to at least one of a quantization matrix and a quantization parameter, and
said control unit is configured to determine a quantization parameter to be used in quantization of the second image to be a value smaller than a quantization parameter to be used in quantization of the first image, when said judgment unit selects the prediction image generated by applying disparity compensation.

8. A stereo video coding method of coding at least a second image included in a second viewpoint video out of a first viewpoint video of a first viewpoint and the second viewpoint video of a second viewpoint, the first viewpoint video and the second viewpoint video making up a video for stereoscopic viewing, said stereo video coding method comprising:
outputting one of a prediction image generated by applying motion compensation to a picture included in the second viewpoint video and a prediction image generated by applying disparity compensation to a picture included in the first viewpoint video, by selectively switching between the prediction images;
calculating a difference between the prediction image output in said outputting and the second image, to generate a residual component;
performing orthogonal transform on the generated residual component, to generate an orthogonal transform coefficient;
performing quantization on the generated orthogonal transform coefficient, to generate a quantization coefficient; and
determining a quantization step size to be used in said performing quantization,
wherein said control unit is configured to determine a quantization step size to be applied to the second image to be a value smaller than a quantization step size to be applied to a first image included in the first viewpoint video, when the prediction image generated by applying disparity compensation is selected in said outputting, the first image being paired with the second image.

9. A non-transitory recording medium having recorded thereon a program for causing a computer to execute the stereo video coding method according to claim 8.

10. An integrated circuit which codes at least a second image included in a second viewpoint video out of a first viewpoint video of a first viewpoint and the second viewpoint video of a second viewpoint, the first viewpoint video and the second viewpoint video making up a video for stereoscopic viewing, said integrated circuit comprising:
a judgment unit configured to output one of a prediction image generated by applying motion compensation to a picture included in the second viewpoint video and a prediction image generated by applying disparity compensation to a picture included in the first viewpoint video, by selectively switching between the prediction images;
a subtractor which calculates a difference between the prediction image output by said judgment unit and the second image, to generate a residual component;
an orthogonal transform unit configured to perform orthogonal transform on the residual component generated by said subtractor, to generate an orthogonal transform coefficient;
a quantization unit configured to perform quantization on the orthogonal transform coefficient generated by said orthogonal transform unit, to generate a quantization coefficient; and
a control unit configured to determine a quantization step size to be used by said quantization unit,
wherein said control unit is configured to determine a quantization step size to be applied to the second image to be a value smaller than a quantization step size to be applied to a first image included in the first viewpoint video, when said judgment unit selects the prediction image generated by applying disparity compensation, the first image being paired with the second image.
